(19) United States
(12) Patent Application Publication
(10) Pub. No.: US 2009/0295919 A1
(43) Pub. Date: Dec. 3, 2009

(54) MONITORING SYSTEMS AND CONTROL METHODS THEREOF

(75) Inventors: Yen-Chao Chen, Taichung (TW); Jung-Ching Wang, Taichung (TW); Hsih-Hsien Yang, Taichung (TW); Shish-Ming Lee, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/264,994

(22) Filed: Nov. 5, 2008

(30) Foreign Application Priority Data
Jun. 2, 2008 (TW) 97120434

(51) Int. Cl. H04N 7/18

(52) U.S. Cl. 348/143; 348/E07.085

(57) ABSTRACT

A monitoring system with two detectors arranged on left and right sides of a camera thereof. The two detectors divide the area around the monitoring system into a non-detectable region, an overlapped detecting region, and first and second non-overlapped detecting regions. According to the detection result of the detectors, the control unit wakes up from a sleep mode when an object leaves the non-detectable region and enters the first or second non-overlapped detecting region. Meanwhile, the control unit turns on the camera to start shooting when the object has further entered the overlapped detecting region.

This Application claims priority of Taiwan Patent Application No. 097120434, filed on Jun. 2, 2008, the entirety of which is incorporated by reference herein.

### BACKGROUND OF THE INVENTION

1. Field of the Invention

The present invention relates to monitoring systems and control methods thereof.

2. Description of the Related Art

For low power consumption and high storage space utility, a monitoring system (or a surveillance system) is usually in a sleep mode and only wakes up for shooting (taking photos or videos) when an object enters a shooting range of a camera of the monitoring system. The conventional techniques usually use one single detector, such as a passive Infrared sensor (PIR), to detect whether an object has entered the shooting range of the camera.

Because the process of waking up the monitoring system takes a lot of time, the object, which triggers the monitoring system, usually leaves the shooting range of the camera before the camera starts shooting. Thus, novel monitoring systems waking up in a timely manner are called for.

### BRIEF SUMMARY OF THE INVENTION

The invention discloses monitoring systems. An exemplary example of the monitoring system comprises a camera, two detectors, and a control unit. The two detectors are arranged on left and right sides of the camera to divide the area around the camera into a non-detectable region, an overlapped detecting region, a first non-overlapped detecting region and a second non-overlapped detecting region. The first and second non-overlapped detecting regions are under the detection of the first and second detectors, respectively, and the overlapped detecting region is detected by both the first and second detectors. The detection results of the first and second detectors are sent to the control unit, and the camera is controlled by the control unit. When the first or second detector detects that an object has entered the first or second non-overlapped detecting region, the control unit wakes up from a sleep mode. When the first and second detectors detect that the object has entered the overlapped detecting region, the control unit controls the camera to start shooting.

The monitoring system may further comprise a sound detector and a sound recorder. The sound detector and sound recorder are coupled to the control unit. In some embodiments, the control unit controls the sound recorder to start recording sound when the sound detector detects a sound louder than a volume threshold. In another embodiment, the control unit further determines whether the camera is shooting when the sound detector detects a sound louder than a volume threshold. When the sound detector detects a sound louder than a volume threshold and the camera is not shooting, the control unit controls the sound recorder to start recording sound.

The invention further discloses control methods of a monitoring system having a camera and a control unit. The control method switches the control unit between a sleep mode, an active mode and a shooting mode. The control unit is usually in the sleep mode to reduce power consumption, and is switched to the active mode when woken up. Furthermore, the control unit controls the camera to start shooting when switched to the shooting mode. An exemplary example of the control method arranges two detectors on left and right sides of the camera, and initializes a first flag and a second flag to a disabled state. The control method wakes up the control unit to the active mode when the first or the second detector detects an object, wherein the control method sets the first flag to an enabled state when the object is detected by the first detector, and sets the second flag to the enabled state when the object is detected by the second detector. There are two conditions for switching the control unit from the active mode to the shooting mode. In the first condition, the first detector detects that an object has entered the detecting area thereof and the second flag is in the enabled state. In the second condition, the second detector detects that an object has entered the detecting area thereof and the first flag is in the enabled state. The control method resets the first and second flags to the disabled state after the camera stars shooting.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates an embodiment of the monitoring system of the invention;

FIG. 2 illustrates another embodiment of the monitoring system of the invention; and

FIG. 3 illustrates a state machine about a motoring system control method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

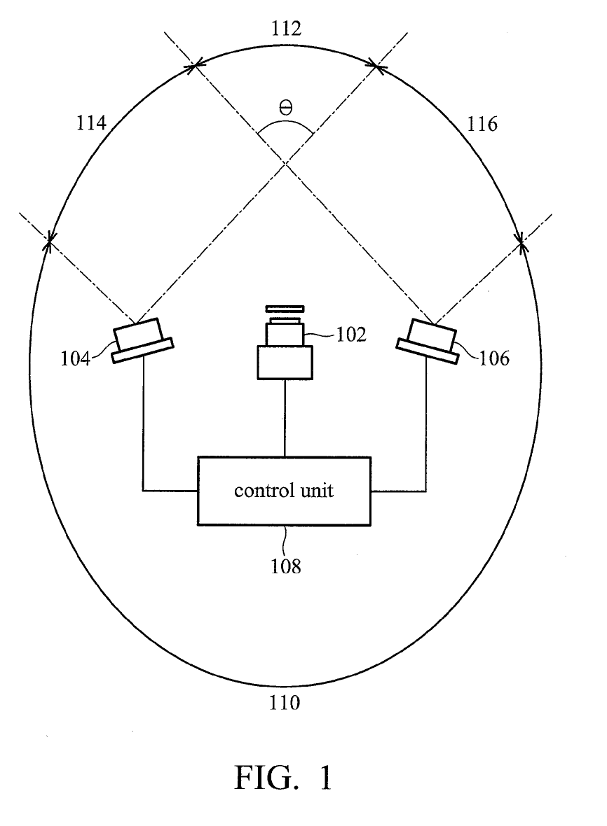

FIG. 1 illustrates an embodiment of the monitoring system of the invention, which comprises a camera 102, a first detector 104, a second detector 106 and a control unit 108. The first and second detectors 102 and 104 are arranged on left and right sides of the camera 102. The area around the monitoring system is divided into a non-detectable region 110, an overlapped detecting region 112, a first non-overlapped detecting region 114 and a second non-overlapped detecting region 116. The first non-overlapped detecting region 114 is detected by the first detector 104. The second non-overlapped detecting region 116 is detected by the second detector 106. The overlapped detecting region 112 is detected by both the first and second detectors 104 and 106. The non-detectable region 110 is a region out of the detecting range of the first and second detectors 104 and 106.

The control unit 108 receives detection results of the first and second detectors 104 and 106, and controls the camera 102. The control unit 108 is usually in a sleep mode. When the first or second detector 104 or 106 detects that an object has entered the first or second non-overlapped detecting region 114 or 116 from the non-detectable region 110, the control unit 108 wakes up from the sleep mode. When the first and second detectors 104 and 106 detect that the object has further entered the overlapped detecting region 112, the control unit 108 controls the camera 102 to start shooting.

Referring to FIG. 1, an angle θ may be designed to vary with a shooting range of the camera 102. In some embodiments, the control unit 108 rotates the first and second detectors 104 and 106 according to a user command which may be determined by the user and includes the shooting range information of the camera 102. In other embodiments, the first and second detectors 104 and 106 are designed to be rotatable, and users can manually rotate them to adjust the angle θ.

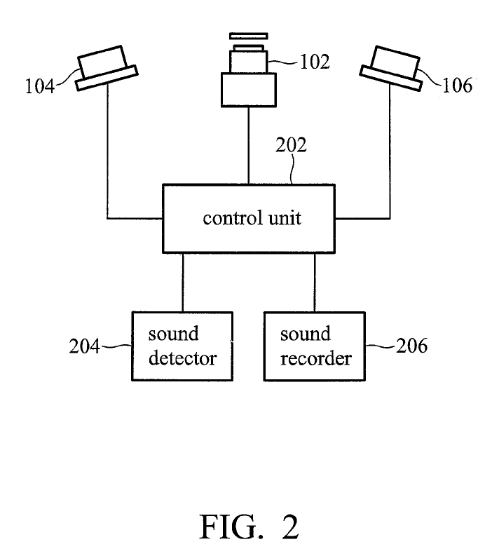

FIG. 2 illustrates another embodiment of the monitoring system. Compared with FIG. 1, the monitoring system further comprises a sound detector 204 and a sound recorder 206. The sound detector 204 and the sound recorder 206 are coupled to the control unit 202. When the sound detector 204 detects a sound louder than a volume threshold, the control unit 202 controls the sound recorder 206 to start recording sound. Thus, in addition to the videos or photos recorded by the camera 102, the monitoring system of FIG. 2 collects audio information.

In some other embodiments of the monitoring system, the control unit 202 further determines whether the camera 102 is shooting when a sound louder than a volume threshold is detected by the sound detector 204. When the sound detector 204 detects a sound louder than a volume threshold and the camera 102 is not shooting, the control unit 202 controls the sound recorder 206 to start recording sound.

The first and second detectors 104 and 106 may be passive Infrared detectors (PIR) or the like. The camera 102 may take photos or videos, or further comprises a sound recording function. The monitoring system of the invention may be applied in surveillance systems or ecological observation systems.

The invention further discloses control methods of a monitoring system having a camera and a control unit. Two detectors are arranged on left and right sides of the camera. The first detector outputs a first signal (such as an interrupt signal) to the control unit when detecting an object. The second detector outputs a second signal (such as an interrupt signal) to the control unit when detecting an object. The control method wakes up the control unit and switches the control unit from a sleep mode to an active mode when the first or second detector sends the first or second signal to the control unit. The control method switches the control unit from the active mode to a shooting mode (for controlling the camera to start shooting) when the first detector detects an object and the second signal has been sent to the control unit for a period of time. Furthermore, the control method switches the control unit from the active mode to the shooting mode when the second detector detects an object and the second signal has been sent to the control unit for a period of time.

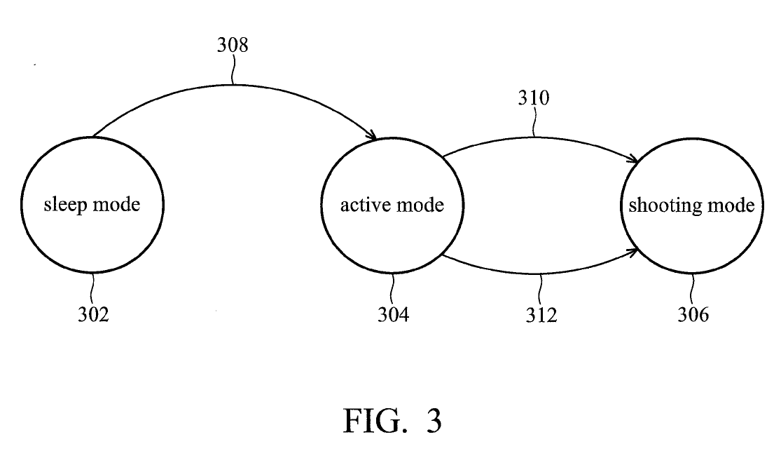

FIG. 3 illustrates how the control unit (108 of FIG. 1) switches between the sleep mode 302, the active mode 304 and the shooting mode 306. The control unit 108 is usually in the sleep mode 302, and is switched to the active mode 304 when the first or second detector 104 or 106 detects an object (trigger 308). In the active mode 304, the control unit 108 is ready to direct the camera 102 to start shooting. The control unit 108 is switched from the active mode 304 to the shooting mode 306 when the first detector 104 detects an object and the second detector 106 has detected the object for a period of time (trigger 310) or when the second detector 106 detects an object and the first detector 104 has detected the object for a period of time (trigger 312).

In addition to arranging a first and a second detector on left and right sides of a camera, another embodiment of the monitoring system control method of the invention further provides a first flag and a second flag. The first and second flags relate to the first and second detectors 104 and 106, respectively, and are initialized at a disabled state. Referring to FIG. 3, the control unit 108 is usually in the sleep mode 302, and is switched to the active mode 304 when the first or second detector 104 or 106 detects an object (trigger 308). When the trigger 308 occurs due to the first detector 104, the first flag is switched to an enabled state. When the trigger 308 occurs due to the second detector 106, the second flag is switched to the enabled state. The control unit 108 is switched from the active mode 304 to the shooting mode 306 when the first detector 104 detects an object and the second flag is in the enabled state (trigger 310) or when the second detector detects an object and the first flag is in the enabled state (trigger 312). This embodiment may reset the first and second flags to the disabled state after the camera 102 starts shooting.

In an embodiment, the monitoring system is further provided with a sound detector and a sound recorder. The control method of the invention further starts recording sound of the sound recorder when the sound detector detects a sound louder than a volume threshold. In another embodiment, the control method of the invention starts recording sound of the sound recorder when the sound detector detects a sound louder than a volume threshold and the camera is not shooting

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A monitoring system, comprising
a camera;
first and second detectors, arranged on left and right sides of the camera to demarcate a non-detectable region, an overlapped detecting region, a first non-overlapped detecting region and a second non-overlapped detecting region, wherein the overlapped detecting region is detected by both the first and second detectors, the first non-overlapped detecting region is detected by the first detector, and the second non-overlapped detecting region is detected by the second detector; and
a control unit, coupled to the first and second detectors and the camera, waking up from a sleep mode when the first or second detector detects that an object has entered the first or second non-overlapped detecting region from the non-detectable region, and controlling the camera to start shooting when the first and second detectors detect that an object has entered the overlapped detecting region.

2. The monitoring system as claimed in claim 1, wherein the control unit further rotates the first and second detectors according to a user command.

3. The monitoring system as claimed in claim 1, further comprising a sound sensor and a sound recorder that are coupled to the control unit.

4. The monitoring system as claimed in claim 3, wherein the control unit controls the sound recorder to start recording sound when the sound sensor detects a sound louder than a volume threshold.

5. The monitoring system as claimed in claim 3, wherein the control unit controls the sound recorder to start recording sound when the sound sensor detects a sound louder than a volume threshold and the camera is not shooting.

6. The monitoring system as claimed in claim 1, wherein the first and second detectors are passive infrared detectors.

7. A method controlling a monitoring system, comprising:
arranging first and second detectors on two sides of a camera of the monitoring system, wherein the first and second detectors are coupled to a control unit controlling the camera, the first detector is operable to output a first signal to the control unit when detecting an specific object, and the second detector is operable to output a second signal to the control unit when detecting the specific object;
waking up the control unit from a sleep mode to an active mode when the control unit receives the first or second signal; and
switching the control unit from the active mode to a shooting mode to control the camera to start shooting when the control unit receives both the first and second signals.

8. The method as claimed in claim 7, further providing a sound detector and a sound recorder

9. The method as claimed in claim 8, further starting recording of sound of the sound recorder when the sound detector detects a sound louder than a volume threshold.

10. The method as claimed in claim 8, further starting recording of sound of the sound recorder when the sound detector detects a sound louder than a volume threshold and the camera is not shooting.

11. A method controlling a monitoring system, comprising:
arranging first and second detectors on left and right sides of a camera of the monitoring system, and initializing first and second flags at a disabled state;
waking up a control unit of the camera from a sleep mode to an active mode and switching the first flag to an enabled state when the first detector detects a specific object;
waking up the control unit from the sleep mode to the active mode and switching the second flag to the enabled state when the second detector detects the specific object;
switching the control unit from the active mode to a shooting mode to control the camera to start shooting when the first detector detects the specific object and the second flag is in the enabled state; and
switching the control unit from the active mode to the shooting mode to control the camera to start shooting when the second detector detects the specific object and the first flag is in the enabled state.

12. The method as claimed in claim 11, further resetting the first and second flags to the disabled state after the camera starting shooting.
